(19) United States
(12) Patent Application Publication
(10) Pub. No.: US 2008/0236689 A1
(43) Pub. Date: Oct. 2, 2008

(54) Gas Valve Assembly for a Barbecue

(75) Inventor: Inigo Albizuri, Muxika (Bizkaia) (ES)

Correspondence Address: BERENBAUM, WEINSHIENK & EASON, P.C, 370 17TH STREET, SUITE 4800, DENVER, CO, 80202, US

(73) Assignee: COPRECITEC, S.L., Aretxabaleta (Gipuzkoa) (ES)

(21) Appl. No.: 12/054,246

(22) Filed: Mar. 24, 2008

(30) Foreign Application Priority Data
Mar. 26, 2007 (ES) U200700654
Mar. 28, 2007 (ES) U200700667

(51) Int. Cl. F16K 27/00; F16K 11/20

(52) U.S. Cl. 137/883; 137/887; 251/151

(57) ABSTRACT

A gas valve assembly for a barbecue is provided. The assembly includes a distributor that has a gas inlet conduit and a diversion conduit connected to the inlet conduit, the diversion conduit comprising branches through which a gas is distributed and including at least one branch, an internally threaded first part and a substantially conic frustrum second part, and a control valve adapted for connection to a burner, the control valve comprising a main body and a connection conduit which is fixed to the at least one branch of the diversion conduit, wherein the connection conduit has a cylindrical externally threaded first segment and a substantially conic frustrum second segment. The first segment is threaded in the first part, and the second segment is compressed when it moves along the second part until the control valve is correctly positioned in relation to the distributor thanks to grooves disposed axially on the surface of the second segment.

### CROSS-REFERENCE TO RELATED APPLICATION

This application claims priority as a regular U.S. Utility Application from the Spanish Application No. U200700667 filed on Mar. 28, 2007, the subject matter of which hereby being incorporated by this reference herein in its entirety as though fully set forth herein.

### TECHNICAL FIELD

The present invention relates to a gas valve and distributor assembly adapted for connection to a barbecue and, specifically, to the fixing of control valves to a distributor.

### BACKGROUND

Outdoor gas barbecues operated by multiple gas valves are known. Dual gas valve assemblies, for example, comprise a pair of control valves that control the passage of gas towards individual burners located in the barbecue and a distributor connected to a gas supply conduit that diverts the gas towards said control valves. Conventional distributors comprise a plurality of branches threaded internally and externally for their connection to the corresponding control valve.

One of the problems presented by this type of threaded connection is the correct positioning of the control valves in relation to the distributor. It is known that said control valves, more specifically the shafts of said control valves, must be inserted into housings disposed on the plate of the barbecue, where they are coupled to control levers, it being necessary for said shafts to be positioned concentrically in relation to said housings. It is necessary, therefore, that said control valves are correctly aligned, which is not always easy to achieve by means of threaded connections. Known threaded connections for fixing control valves to the distributor comprise a conic frustrum thread that moves inside a cylindrical thread of the distributor, said conic frustrum thread gradually being compressed during its movement.

In addition, this type of threaded connection restricts to a certain extent the use of materials in the manufacture of gas valves due to the compression suffered by the threaded element. Thus, for example, the use of brass in this type of thread is known, but not aluminium, as said material cannot withstand significant compressions, with the thread breaking easily.

U.S. Pat. No. 6,199,589 B1 discloses a dual valve assembly that comprises a pair of control valves and a distributor connected to said control valves. The distributor comprises a gas inlet with a central axis, and a first and second diversion branch, both symmetrical in relation to the central axis, and each control valve comprises a main body with a cylindrical extension that extends towards the exterior continuously from said main body and which is housed in the first and second branch respectively of the distributor. For the fixing of said extensions to the distributor, each diversion branch has a flat end bent towards the inside of the branch, and the cylindrical extension of each control valve includes a flat part so that once it has been fixed by means of the internal bend, the control valve is prevented from rotating. In other embodiments an O-ring seal is also added between the cylindrical extension inserted inside the branch in order to improve the sealing of the connection.

### SUMMARY OF THE DISCLOSURE

An object of the invention is to provide a gas valve assembly adapted for connection to a barbecue as defined in the claims and as described herein.

In one embodiment a dual gas valve assembly is provided that comprises a distributor that has a gas inlet conduit, and a diversion conduit connected to said inlet conduit and which comprises two branches through which gas is distributed, and two control valves adapted for their connection to a burner, each control valve comprising a main body and a connection conduit that extends continuously projecting itself from a lateral or other surface of said main body, the connection conduit of each control valve being fixed to each respective branch of the diversion conduit.

The connection conduit has a cylindrical externally threaded first segment and a substantially conic frustrum second segment, coaxial and adjacent to the first segment, the diversion conduit includes on each branch a first part threaded internally and a substantially conic frustrum second part, coaxial and adjacent to the first part, so that said first segment is threaded into said first part, and said second segment is compressed when it moves along the second part until each control valve is correctly positioned in relation to the distributor thanks to grooves disposed axially on the conic frustrum surface of the second segment, which absorb said deformation.

This type of fixing system in combination with sealing means provides a gas-tight connection, and prevents an incorrect positioning of each control valve in relation to the distributor as said second part acts as a stopper for said positioning, unlike the conic frustrum brass threads known in the prior art, which are not disposed with a stopper that restricts the rotation of the control valve. The inventive fixing system also prevents, once the unit has been assembled, said control valves from rotating on the distributor, and it is not the thread that suffers the deformation until the positioning of the control valve in the required position but the unthreaded second segment of the connection conduit, thus preventing possible breakages of the threads.

These and other advantages and characteristics of the invention will be made evident in the light of the drawings and the detailed description thereof. It is important to note that the present invention is applicable to valve assemblies having more than two control valves.

### BRIEF DESCRIPTION OF THE DRAWINGS

FIG. 1 is an exploded view of an embodiment of a valve assembly according to the invention.

FIG. 2 is a three-dimensional view of the valve assembly of FIG. 1 assembled.

FIG. 3 is a lateral view of the distributor in the valve assembly of FIG. 1.

FIG. 4 is a cross-sectional view of the distributor of FIG. 3 according to the IV-IV line.

FIG. 5 is a three-dimensional view of one of the two gas valves in the valve assembly of FIG. 1.

FIG. 6 is a lateral view of one of the two gas valves in the valve assembly of FIG. 1.

FIG. 7 is a detailed cross-sectional view that shows a connection conduit of the control valve threaded in the internal distributor to a position at which the end of the connection conduit comes into contact with said distributor in an embodiment of the present invention.

FIG. 8 is a detailed cross-sectional view that shows the final position of a connection conduit of the control valve inside the distributor in an embodiment of the present invention.

FIG. 9 is a detailed cross-sectional view that shows a connection conduit of the control valve threaded in the internal distributor to a position at which the end of the connection conduit comes into contact with said distributor in another embodiment of the present invention.

FIG. 10 is a detailed cross-sectional view that shows the final position of a connection conduit of the control valve inside the distributor in another embodiment of the present invention.

### DETAILED DESCRIPTION

In the following description, numerous specific details are set forth in order to provide a thorough understanding of the present invention. It will be understood, however, to one skilled in the art, that the present invention may be practiced without some or all these specific details. In other instances, well known process operations have not been described in detail in order not to unnecessarily obscure the present invention.

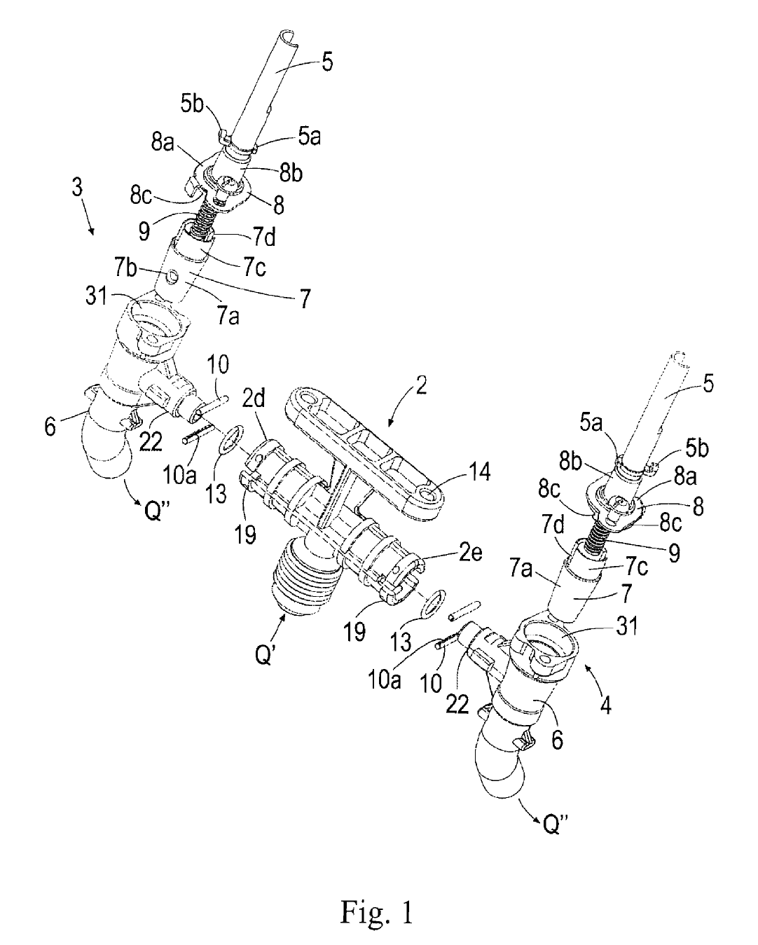

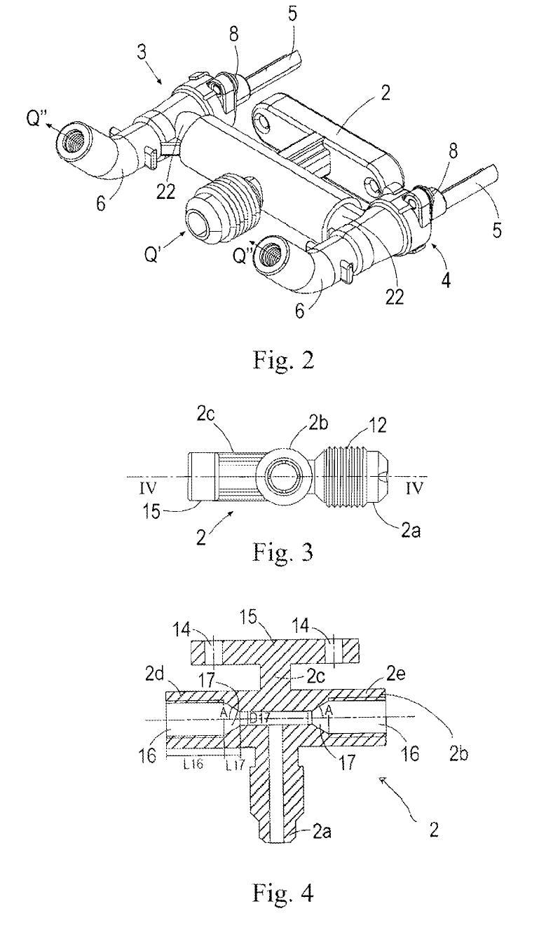

FIGS. 1 and 2 show a gas valve assembly adapted to a barbecue (not shown in the figures) in an embodiment of the invention. The gas valve assembly comprises a distributor 2 that distributes an inlet gas Q′ towards control valves 3 and 4, disposed on both sides of said distributor 2.

The distributor 2, shown in detail in FIGS. 3 and 4, is made of a lightweight, malleable material, preferably aluminium, and preferably obtained by a stamping procedure. Said distributor 2 has a gas inlet conduit 2a and a substantially cylindrical diversion conduit 2b, which is connected to said inlet conduit 2a and which distributes the inlet gas Q′ through branches 2d and 2e of said diversion conduit 2b, said branches 2d and 2e being coaxial. In alternative embodiments branches 2d and 2e are not coaxial.

In one embodiment the inlet conduit 2a is disposed perpendicularly and symmetrically in relation to said diversion conduit 2b, substantially forming a “T” with said diversion conduit 2b and it has an exterior thread 12 through which said distributor 2 is fixed to a gas conduit not shown in the figures. The distributor 2 also includes a support element 2c that extends continuously and perpendicularly in the form of a “T”, from a lateral surface of the diversion conduit 2b, so that its axis of symmetry coincides with the axial axis of the inlet conduit 2a. The base 15 of the support element 2c comprises symmetrical fixing holes 14 for the fixing of the valve assembly to a support of the barbecue not shown in the figures. Other types of support elements which are capable of fixing the valve assembly to a support of a barbecue may also be used.

In the embodiments of FIGS. 1 and 2 the control valves 3 and 4, which are fixed to each respective branch 2d and 2e of the diversion conduit 2b, are specular to each other and, as a result, one of them will be described from this point onwards, said description being valid for the corresponding specular area. In alternative embodiments of the invention the control valves are neither specular nor identical to one another.

The control valve 3 shown in its entirety in FIGS. 1 and 2 comprises a valve shaft 5 adapted in order to be fixed to a control lever not shown in the figures, a main body 6 with a connection conduit 22 that is fixed to an end of the branch 2d of the diversion conduit 2b, a regulator element 7 coupled to the valve shaft 5 and inserted into said main body 6, and a fixing support 8 that connects the valve shaft 5 to said main body 6.

Said fixing support 8 has a base plate 8a with ears that are screwed to the main body 6, a cylindrical prolongation 8b that extends axially from one of the surfaces of the base plate 8a, housing the valve shaft 5 in its interior, and peripheral edges 8c that extend axially from the opposite surface of the base plate 8a, and which are housed in the cavity 31 of the main body 6. The valve shaft 5 is disposed with an end, a first flat radial tab 5a and a second radial tab 5b that extends longitudinally according to the axial axis of said valve shaft 5, which come up against the base plate 8a thereby preventing the disassembly of the valve shaft 5 in relation to the valve body 6.

The regulator element 7 comprises a hollow main member 7a with a substantially conic frustrum shape, which includes a through hole 7b on the lateral surface, so that to enable the passage of gas Q″ to the burners, the regulator element 7 is rotated by means of the lever until said through hole 7b coincides with the connection conduit 22 of the main body 6. Said regulator element 7 also comprises a cylindrical body 7c that extends axially from the main member 7a, a spring 8 being housed in its interior and whose other end comes up against the base plate 8a, and with said cylindrical body 7c including a pair of coaxial cuts 7d in which are housed the radial tabs 5a and 5b of the valve shaft 5.

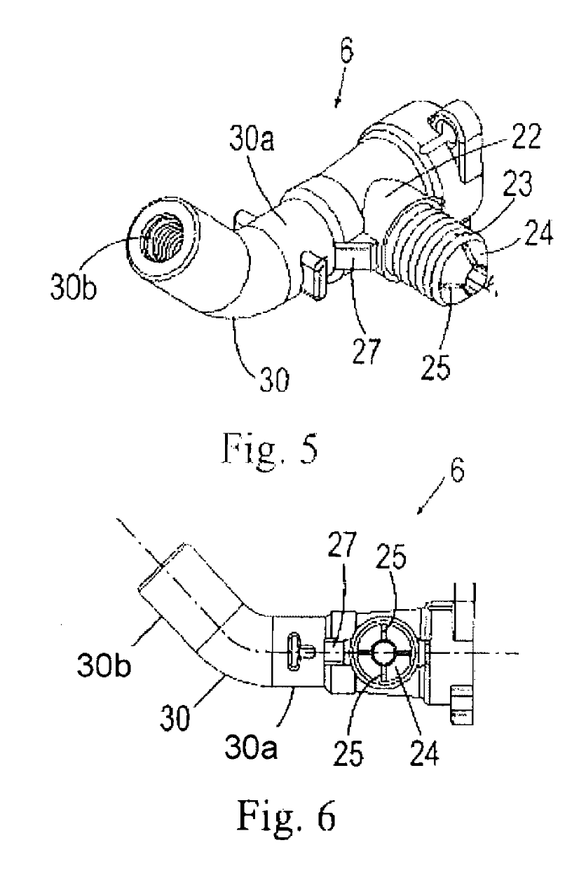

Furthermore, the main body 6 of revolution, shown in detail in FIGS. 3 to 6, has a cavity 31 in which is housed the conic frustrum regulator element 7 and an outlet conduit 30 with a first part 30a typically coaxial with the main body 6 and connected to said cavity 31, and with a second part 30b whose axial axis may form an angle with the axial axis of the first part 30a, said second part 30b being threaded internally for its fixing to a burner.

The diversion conduit 2b includes in its interior, on the end of each branch 2d y 2e, a threaded first part 16 of a length L16 and a thread pitch r, and an unthreaded conic frustrum second part 17, the first part 16 and the second part 17 being adjacent to each other and coaxial with the diversion conduit 2b, with said second part 17 being defined by a diameter D17 of the end not adjacent to the first part 16 that is smaller than the internal diameter of the first threaded part, a length L17 smaller than the length L16 of thread and a convergence angle A in relation to the axis of revolution.

In addition, the connection conduit 22, whose axis of revolution is typically substantially perpendicular to the axis of revolution of the main body 6, has a threaded first segment 23 with a thread pitch r and a second segment 24 coaxial and adjacent to said first segment 23. The second segment 24 has a substantially conic frustrum shape defined by a diameter D24 of the free end that is smaller than the thread diameter, a length L24 equal or greater than the thread pitch, and a convergence angle B in relation to the axis of revolution, and comprises preferably uniformly disposed axial grooves 25. In an initial position in which the second segment 24 is not subject to compression, the angle B is smaller than the angle A of the second part 17 of the diversion conduit 2b. In one embodiment the threaded first segment 23 has a pitch r of 1 mm.

In this way, when the control valves 3 and 4 are fitted on the respective branches 2d and 2e of the distributor 2, the respective connection conduit 22 is threaded manually without being deformed and without effort up to a position shown in FIG. 7, in which the free end of the second segment 24 of the connection conduit 22 comes into contact with the second part 17 of the diversion conduit 2b. In said position the other end of the second segment 24, remains at a distance from the end of the threaded first part 16 of the diversion conduit 2b. In one embodiment the distance is equal to the thread pitch r, as shown in FIG. 7.

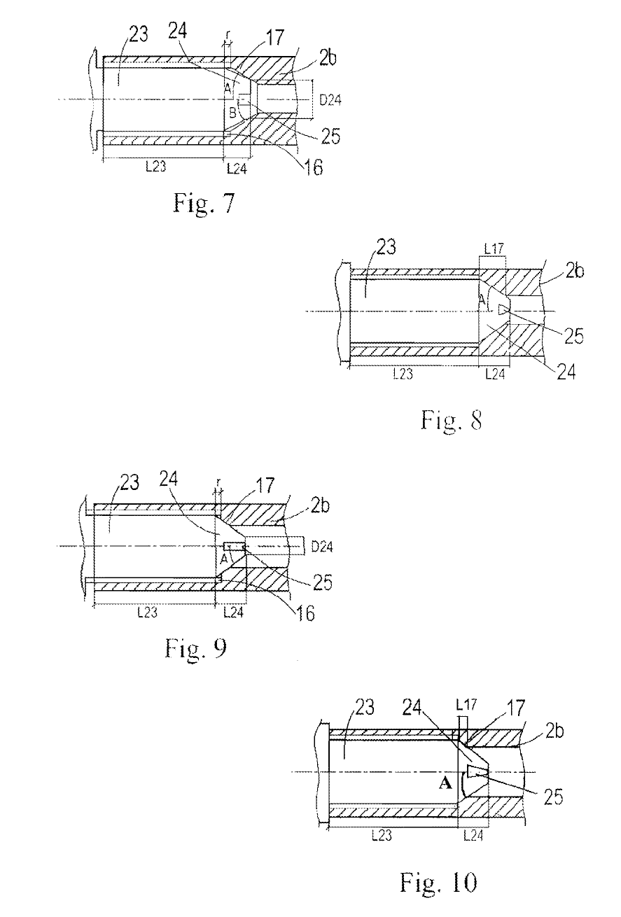

From said position, and in order to ensure that the connection conduit 22, and therefore the control valve 3, is positioned correctly in relation to the distributor 2 as shown in FIG. 2, a final rotation of the thread of said connection conduit 22 must be completed. The final rotation may be a full rotation of the thread or fractions or multiples thereof. Said final rotation of thread requires the necessary manual force to ensure that the connection conduit 22 continues to advance inside the diversion conduit 2b, for which purposes the conic frustrum second segment 24 must be compressed in its movement along the conic frustrum second part 17, the angle B of said second segment 24 coinciding with the angle A of the second part 17. Compression is obtained thanks to the uniformly disposed grooves 25, shown in FIGS. 5 to 8, with the result that the height and depth dimensions and the necessary number of grooves are determined in accordance with the conic frustrum shape of the second segment 24 and of the second part 17, as well as the thread pitch r. It is thus the conic frustrum second segment 24 of the connection conduit 22 that absorbs the deformation to which said connection conduit 22 is subjected and not, therefore, the first threaded segment 23. It is important to note that grooves 25 need not be uniformly spaced nor are they required to have the same shape.

Finally, in order to ensure the threaded connection is gas-tight, adhesive leak-sealing means used in known threaded elements are employed. In alternative embodiments, O-rings or other known sealing means may be incorporated into the device to effectuate a gas-tight seal.

In another embodiment of the invention, shown in FIGS. 9 and 10, the angle B of the conic frustrum second segment 24 of the connection conduit 22 is equal to the angle A of the second part 17 of the diversion conduit 2b. In this way, when the control valves 3 and 4 are fitted on the respective branches 2d and 2e of the distributor 2, the respective connection conduit 22 is threaded manually without being deformed and without effort up to a position shown in FIG. 9, in which the second segment 24 of the connection conduit 22, of length L24, passes through the second part 17 of the diversion conduit 22 until said segment 24 comes into contact with the second part 17 of the diversion conduit 2b of length L17, said length L17 being smaller than the length L24. In this position the end of the second segment 24 adjacent to the first element 23, remains at a distance from the end of the threaded first part 16 of the diversion conduit 2b. In one embodiment the distance is equal to the thread pitch r, as shown in FIG. 9.

From said position, and in order to ensure that the connection conduit 22, and therefore the control valve 3, are positioned correctly in relation to the distributor 2 as shown in FIG. 2, a final rotation of the thread of said connection conduit 22 must be completed. The final rotation may be a full rotation of the thread or fractions or multiples thereof. Said final rotation of thread requires the necessary manual force to ensure that the connection conduit 22 continues to advance inside the diversion conduit 2b, for which purposes the conic frustrum second segment 24 must be compressed in its movement along the conic frustrum second part 17 thanks to the grooves 25.

Other embodiments of the invention will be appreciated by those skilled in the art from consideration of the specification and practice of the invention. Furthermore, certain terminology has been used for the purpose of descriptive clarity, and not to limit the present invention. The embodiments and preferred features described above should be considered exemplary, with the invention being defined by the appended claims.

What is claimed is:

1. A gas valve assembly adapted for connection to a barbecue, comprising:
a distributor having a gas inlet conduit and a diversion conduit connected to the inlet conduit, the diversion conduit having a threaded first part and a substantially conic frustrum second part that is adjacent to the first part, and
a control valve adapted for connection to a burner in the barbecue, the control valve comprising a main body and a connection conduit that extends from a surface of the main body, the connection conduit of the control valve being fixed to the diversion conduit, the connection conduit having a threaded first segment and a substantially conic frustrum second segment that is substantially coaxial and adjacent to the threaded first segment, the conic frustrum second segment having one or more grooves enabling compression of the conic frustrum second segment,
the threaded first segment and the threaded first part being threaded together with the conic frustrum second segment being compressed by aid of the one or more grooves within the conic frustrum second part.

2. A gas valve assembly according to claim 1 wherein the threaded first segment has a thread pitch, the length of the conic frustrum second segment being equal or greater than the thread pitch of the threaded first segment.

3. A gas valve assembly according to claim 1 wherein the conic frustrum second segment is defined by a first convergence angle and the conic frustrum second part is defined by a second convergence angle, the first convergence angle being smaller than the second convergence angle.

4. A gas valve assembly according to claim 3 wherein the conic frustrum second segment has a first end and a second end, the first end having a diameter less than the second end, when the first end of the conic frustrum second segment of the connection conduit comes into contact with the conic frustrum second part of the diversion conduit, the distance between the second end of the conic frustrum second segment and the end of the threaded first part of the diversion conduit is equal to the thread pitch of the threaded first segment.

5. A gas valve assembly according to claim 1 wherein the conic frustrum second segment is defined by a first convergence angle and the conic frustrum second part is defined by a second convergence angle, the first convergence angle and the second convergence angle being substantially equal.

6. A gas valve assembly according to claim 5 wherein the conic frustrum second segment has a first end and a second end, the first end having a diameter less than the second end, when the first end of the conic frustrum second segment of the connection conduit comes into contact with the conic frustrum second part of the diversion conduit, the distance between the second end of the conic frustrum second segment and the end of the threaded first part of the diversion conduit is equal to the thread pitch of the threaded first segment.

7. A gas valve assembly according to claim 1 wherein the diversion conduit comprises an internally threaded first part and the connection conduit comprises an externally threaded first segment.

8. A gas valve assembly according to claim 1 wherein the grooves are axially oriented and uniformly spaced about the conic frustrum second segment.

9. A gas valve assembly according to claim 1 wherein the distributor is made of aluminum and has been manufactured by means of a stamping procedure.

10. A gas valve assembly according to claim 1 wherein the control valves are made of aluminum and have been manufactured by means of a stamping procedure.

11. A gas valve assembly adapted for connection to a barbecue, comprising:
a distributor having a gas inlet conduit and a diversion conduit connected to the inlet conduit, the diversion conduit comprising a plurality of branches through which a gas is distributed, each of the branches including a threaded first part and a substantially conic frustrum second part that is adjacent to the first part, and
a plurality of control valves adapted for connection to a burner in the barbecue, each of the control valves comprising a main body and a connection conduit that extends from a surface of the main body, the connection conduit of the control valves being fixed to a respective branch of the diversion conduit, the connection conduit having a threaded first segment and a substantially conic frustrum second segment that is substantially coaxial and adjacent to the threaded first segment, the conic frustrum second segment having one or more grooves enabling compression of the conic frustrum second segment,
the threaded first segment and the threaded first part being threaded together with the conic frustrum second segment being compressed by aid of the one or more grooves within the conic frustrum second part.

12. A gas valve assembly according to claim 11 wherein the threaded first segment has a thread pitch, the length of the conic frustrum second segment being equal or greater than the thread pitch of the threaded first segment.

13. A gas valve assembly according to claim 11 wherein the conic frustrum second segment is defined by a first convergence angle and the conic frustrum second part is defined by a second convergence angle, the first convergence angle being smaller than the second convergence angle.

14. A gas valve assembly according to claim 13 wherein the conic frustrum second segment has a first end and a second end, the first end having a diameter less than the second end, when the first end of the conic frustrum second segment of the connection conduit comes into contact with the conic frustrum second part of the diversion conduit, the distance between the second end of the conic frustrum second segment and the end of the threaded first part of the diversion conduit is equal to the thread pitch of the threaded first segment.

15. A gas valve assembly according to claim 11 wherein the conic frustrum second segment is defined by a first convergence angle and the conic frustrum second part is defined by a second convergence angle, the first convergence angle and the second convergence angle being substantially equal.

16. A gas valve assembly according to claim 15 wherein the conic frustrum second segment has a first end and a second end, the first end having a diameter less than the second end, when the first end of the conic frustrum second segment of the connection conduit comes into contact with the conic frustrum second part of the diversion conduit, the distance between the second end of the conic frustrum second segment and the end of the threaded first part of the diversion conduit is equal to the thread pitch of the threaded first segment.

17. A gas valve assembly according to claim 11 wherein the grooves are axially oriented and uniformly spaced about the conic frustrum second segment.

18. A gas valve assembly according to claim 11 wherein the distributor is made of aluminum and has been manufactured by means of a stamping procedure.

19. A gas valve assembly according to claim 11 wherein the control valves are made of aluminum and have been manufactured by means of a stamping procedure.

20. A gas valve assembly adapted for connection to a barbecue, comprising:
a distributor that has a gas inlet conduit and a diversion conduit connected to the inlet conduit, the diversion conduit comprising two branches through which a gas is distributed and including on each branch an internally threaded first part and a substantially conic frustrum second part coaxial and adjacent to the first part, and
two control valves adapted for connection to a burner, each control valve comprising a main body and a connection conduit that extends continuously projecting itself from a lateral surface of the main body, the connection conduit of each control valve being fixed to each respective branch of the diversion conduit, wherein the connection conduit has a cylindrical externally threaded first segment and a substantially conic frustrum second segment, coaxial and adjacent to the first segment.
the threaded first segment being threaded in the threaded first part with the conic frustrum second segment being compressed by aid of one or more grooves within the conic frustrum second part.
